(19) United States
(12) Patent Application Publication
(10) Pub. No.: US 2010/0198522 A1
(43) Pub. Date: Aug. 5, 2010

(54) Computer-Assisted Method of Analyzing a DNA Mixture

(75) Inventors: Torben TVEDEBRINK, Aalborg East (DK); Helle Smidt MOGENSEN, Copenhagen East (DK); Poul Svante ERIKSEN, Aalborg East (DK); Niels MORLING, Copenhagen East (DK)

Correspondence Address: CROCKETT & CROCKETT, P.C., 26020 ACERO, SUITE 200, MISSION VIEJO, CA, 92691, US

(73) Assignee: AALBORG UNIVERSITET, Aalborg (DK)

(21) Appl. No.: 12/695,849

(22) Filed: Jan. 28, 2010

Related U.S. Application Data
(60) Provisional application No. 61/148,221, filed on Jan. 29, 2009.

(51) Int. Cl. G06F 17/18; G06F 19/00

(52) U.S. Cl. 702/19; 702/179

(57) ABSTRACT

The present invention relates to a computer-assisted method of analyzing a DNA mixture having two or more individual contributors by use of STR technology. The method comprises the steps of obtaining, for a number of STR loci, observed peak area data vector and observed peak height data vector for each peak within a locus, and observed allele data informing which alleles are observed for each loci; and obtaining peak area model data for peak areas by use of a statistical model assuming a normal distribution for the peak areas and assuming conditional independence of the peak area vectors given the sums of the peak areas within each locus. A conditional mean vector and a conditional covariance matrix is proposed and used for the statistical model. The invention also proposes a method for determining, for each locus of the STR loci and by use of the proposed statistical model, a best matching combination of variables indicating the number of allele copies from each individual contributor to the mixture and thereby specifying the DNA mixture.

This application claims priority to U.S. Provisional Application 61/148,221 filed Jan. 29, 2009.

### FIELD OF THE INVENTION

The present invention relates to a computer-assisted method of analyzing a DNA mixture having two or more individual contributors by use of STR technology.

### BACKGROUND OF THE INVENTION

When making DNA analysis using the STR technology there are two types of data available: quantitative peak intensity information summarized by the height and area of the peak, and qualitative allele type information, which is determined by the position of the peak. The number of possible alleles (i.e. possible positions of the peak due to genetic variation) is typically in the range 5-20. These data are gathered from different places on the genome called loci (plural of locus). The number of loci is typically in the range of 10-15 and for each locus, we have information about allele, height and area of the peak. The commercial kits applied for identification purposes uses loci located on different chromosomes. This ensures statistical independence of the loci with respect to the allelic profiles due to the Mendelian inheritance laws. If the data originates from a DNA mixture where more than one individual has contributed the quantitative data are important for interpretation. Several studies describe how the amount of DNA contributed by different donors is reflected in the observed peak intensities in the STR analysis. Since the patterns in the data may be very complex an objective statistical method is needed in order to compare different hypotheses about the origin of the stain against each other.

It is an object of the present invention to provide such an objective statistical method.

### SUMMARY OF THE INVENTION

According to the present invention there is provided a computer assisted method of analyzing a DNA mixture having two or more individual contributors m by use of STR technology, said method comprising:
(1.a) obtaining, for a number S of STR loci, observed peak area data vector and observed peak height data vector for each peak within a locus, and observed allele data informing which alleles are observed for each locus;
(1.b) obtaining peak area model data for peak area vectors (A₁, . . . , A_{S}) by use of a statistical model assuming a normal distribution for the peak areas and assuming conditional independence of the peak area vectors given the sums of the peak areas within each locus;
(1.c) wherein for the statistical model a conditional mean vector is given by

$$E ( {A}_{s} \vert {A}_{s , +} ) = \frac{{A}_{s , +}}{2} {\sum }_{i = 1}^{m} {α}_{i} {P}_{s , i} ,$$

where A_{s,+} is the sum of peak areas within locus s, (α₁, . . . , αₘ) is a mixture ratio parameter vector with αᵢ denoting the share that individual i has contributed to the DNA mixture and α₁< . . . <αₘ are ordered in increasing order, and where P_{s,i} is a vector variable of indicators giving the number of copies that contributor i has of each allele in the DNA mixture of locus s;
(1.d) and wherein for the statistical model a conditional covariance matrix is given by Cov(Aₛ|A_{s,+})=τ²Cₛdiag(hₛ)Cₛ^{T}, where τ is a variance parameter being a common variance to all loci, diag(hₛ) is a diagonal matrix with the associated peak heights on locus s, Cₛ=lₙ_{ₛ}−n⁻¹1ₙ_{ₛ}1ₙ_{ₛ}^{T}, where nₛ is the number of observed peaks at locus s, lₙ is the n-dimensional identity matrix, and 1ₙ is an n-dimensional column-vector of ones;
(1.e) said method further comprising determining an estimate for the mixture ratio vector (α₁, . . . , αₘ), and further determining an estimate for the variance parameter τ, said estimations being based on a comparison of the obtained peak area data and the modeled peak area data.

It is preferred that the estimate of the mixture ratio vector and the variance parameter is performed by use of bias-corrected maximum likelihood estimators. It is within a preferred embodiment of the invention that the method further comprises determining, for each locus s of the S loci and by use of the statistical model defined in (1.b)-(1.d), a best matching combination [P_{s,1}, . . . , P_{s,m}] of variables indicating the number of allele copies from each contributor, 1, . . . , m, to the mixture and thereby specifying the DNA mixture, said best matching combination being the combination giving the smallest variance parameter τ.

Here, the method of determining the best matching combination may comprise the steps of:
(1.f) estimating the mixture ratio vector (α₁, . . . , αₘ) and the variance τ for all loci with 2m observed peaks using the statistical model defined in (1.b)-(1.d), and setting P_{s,i} fixed such that it assigns the two lowest peaks to contributor 1, the two next lowest peaks to contributor 2 and so forth;
(1.g) estimating the mixture ratio vector (α₁, . . . , αₘ) and the variance τ for each of the remaining loci and for each allowable combination of the indicator variable [P_{s,1}, . . . , P_{s,m}] using the statistical model defined in (1.b)-(1.d), taking one locus at the time and starting with the loci having most peaks and then in a decreasing order of peaks, identifying a best matching combination of [P_{s,1}, . . . , P_{s,m}], which minimizes the estimate of τ, while the mixture ratio vector (α₁, . . . , αₘ) for each combination of [P_{s,1}, . . . , P_{s,m}] under consideration is re-estimated based on the identified combinations [P_{s,1}, . . . , P_{s,m}] of previously visited loci and the identified combination of [P_{s,1}, . . . , P_{s,m}] at the current locus in order to ensure that the mixture ratio (α₁, . . . , αₘ) tits with both the previously visited loci and the current locus, where the estimated mixture ratio vector for the selected combination of indicator variables [P_{s,1}, . . . , P_{s,m}] satisfies α₁< . . . <αₘ; and
(1.h) storing the obtained best matching combinations of [P_{s,1}, . . . , P_{s,m}] and the resulting estimate of the mixture ratio vector (α₁, . . . , αₘ) and the resulting minimum estimate of the variance τ, which is the weigthed mean with weights (nₛ−1) of the obtained minimum estimates of τₛ for each locus s.

It is preferred that the determining of said the best matching combination further comprises the steps of:
(1.i) determining for each locus, while using the statistical model defined in (1.b)-(1.d), if there is a combination of indicator variables [P_{s,1}, . . . , P_{s,m}] resulting in a lower estimate of the variance τ than for the already identified best matching combination, while maintaining the identified best matching combinations of [P_{s,1}, . . . , P_{s,m}] for the remaining loci, and if there is any such new combination, identifying said new combination as the best matching combination for the locus being investigated, and updating the resulting minimum estimate of the variance τ;
(1.j) returning for each locus the obtained best matching combination [P_{s,1}, . . . , P_{s,m}] of variables, and further returning the obtained resulting minimum estimate of the variance τ and the resulting estimate of the mixture ratio (α₁, . . . , αₘ).

Other objects, features and advantages of the present invention will be more readily apparent from the detailed description of the preferred embodiments

### BRIEF DESCRIPTION OF THE DRAWINGS

FIG. 1 shows a pseudo code for a greedy algorithm finding a pair of DNA profiles being a best match in an observed DNA mixture having two contributors,

FIG. 2 shows a pseudo code a greedy algorithm finding a set of DNA profiles being a best match in an observed DNA mixture having two or more contributors,

FIG. 3 is a plot produced by an implementation of the algorithm of FIG. 1 and showing a comparison of observed loci peaks and expected loci peaks for the best matching combination recovered by the greedy algorithm of FIG. 1,

FIG. 4 shows a trace plot of the parameter estimates of the mixture ratio α (dashed) and the variance parameter τ² (solid) associated with the algorithm implementation for the same case as exemplified in FIG. 3,

FIG. 5 is a plot produced by an implementation of the algorithm of FIG. 1 and showing a comparison of observed loci peaks and expected loci peaks assuming a DNA mixture of a fixed suspect profile and a best matching unknown profile,

FIG. 6 shows a histogram of 1,000 estimates of the probability P(E|H_{d}) for the same case as in FIGS. 3-5, where each estimate is based on importance sampling using 10,000 samples per estimate,

FIG. 7 is a symbolic chart corresponding to the algorithm of FIG. 2 and symbolizing a method of determining the best matching combination of variables indicating the number of allele copies from each contributor to an observed DNA mixture,

FIG. 8 is a flowchart illustrating how an algorithm corresponding to FIG. 1 or FIG. 2 may be incorporated in the work at a forensic laboratory,

FIG. 9 is a flowchart showing the steps of the method corresponding to the symbolic chart of FIG. 7, and

FIG. 10 is a flowchart showing the general steps of the sample preparation and data generation. The laboratory's standard protocols are used in the sample processing phase. The obtained data spreadsheet is given as input to the separation algorithm described in FIG. 1 or FIG. 2.

### DETAILED DESCRIPTION OF THE INVENTION

### Introduction

Our model is based on data analysis of controlled experiments conducted at The Section of Forensic Genetics, Department of Forensic Medicine, Faculty of Health Sciences, University of Copenhagen, Denmark. Four different DNA profiles were mixed in pairwise mixtures of different mixture ratios. The preliminary analysis showed proportionalities of:
peak areas and peak heights
peak area and amount of DNA in the mixture
the mean and variance of the peak areas.

When formulating our statistical model we used these findings when defining the mean and covariance structure (see equation (1) in the detailed description).

In a DNA mixture the observed peak heights are assumed to be a sum of individual contributions from the different donors. Shared (when more than one individual has a copy of the same allele) and homozygotic (when an individual carries two copies of the same allele) peaks will be a sum of the contributing peaks. In particular, for a two-person mixture the peaks related to the major contributor will be larger than those of the minor contributor. We assume a common mixture ratio α for all loci, where αε(0,0.5) is the share contributed by the minor contributor. The variance parameter τ measures the agreement between the observed and expected peaks. The observed peaks are the input data, whereas the latter are the peaks we would expect to see if the proposed profiles (and mixture ratio) were true. The statistical model does not incorporate the modeling of stutters or drop-outs. Hence, we assume stutter effects have been filtered out in the input data and that no alleles have dropped out.

In addition to formulating a statistical model we also present an algorithm for separating a mixed stain and finding the most likely combination of profiles constituting the observed data. This best matching combination of profiles must be chosen from a finite list since there is a finite number of loci and possible combinations for each locus. However, it is not feasible to consider all possible combinations due to the number of computations. For each locus the number of possible combinations depends on the number of observed peaks and the assumed number of donors to the mixture. Each individual carries two alleles (if identical, the individual's profile is homozygotic) and when no drop-outs or stutters are assumed there may be one to 2m different alleles present in a mixture at one locus. In Table 1 we have listed the possible combinations for a two-person mixture when observing one to four alleles.

TABLE 1
List of possible combinations in a two-person mixture
observing one to four alleles.

| Obs | |
|---|---|
| alleles | Possible combinations |
| a | (aa, aa) |
| a, b | (aa, ab) (aa, bb) (ab, aa) (ab, ab) (ab, bb) (bb, ab) (bb, aa) |
| a, b, c | (aa, bc) (ab, ac) (ab, bc) (ab, cc) (ac, ab) (ac, bb) |
| | (ac, bc) (bb, ac) (bc, ab) (bc, ac) (bc, aa) (cc, ab) |
| a, b, c, d | (ab, cd) (ac, bd) (ad, bc) (bc, ad) (bd, ac) (cd, ab) |

The algorithm initiates by analyzing the loci with four observed peaks. Based on these loci we obtain an estimate of a which is used in the succeeding steps of the algorithm. For every locus we investigate which of the plausible (see Table 2 in the detailed description) combinations contributes the least to τ. In each step the algorithm chooses the combination minimizing τ while updating α. This makes the algorithm a “greedy algorithm”, however, in most practical situations the algorithm will find the global maximum.

The output from the algorithm is aside from the combination of best matching profiles, an estimate of the mixture ratio, α, and the variance parameter τ. The output must after termination be interpreted by the forensic geneticist. Since the peak 5 areas are assumed to follow a normal distribution, the likelihood value of the best matching combination is given by τ−N₊, where N₊=n₊−S−1 with n₊ being the total number of observed peaks and S the number of loci in the data. Hence, the smaller τ is, the larger is the likelihood-value of the combination. This makes the interpretation less subjective since agreement between the expected and observed peak intensities is measured by τ.

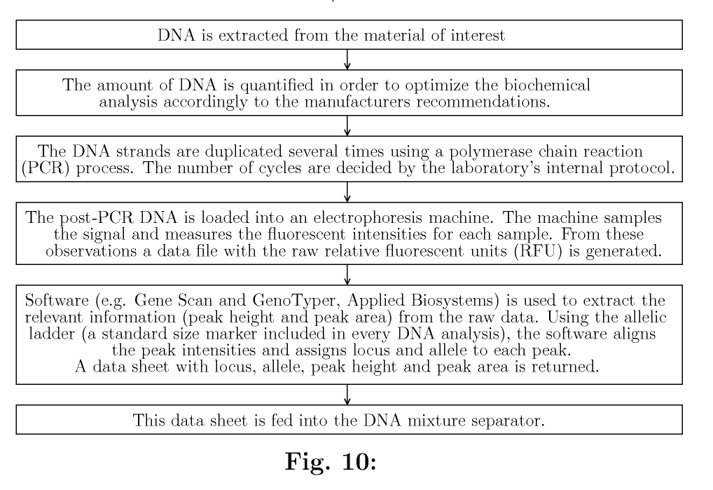

In FIG. 10, the flowchart shows how the data used as input to the algorithm are produced using the laboratory's standard protocols. The present method is used in the signal interpretation phase of the analysis. Hence, it is assumed that the methods used during the data generation is state-of-the-art and in concordance with the recommendation of advisory bodies. This applies to all phases of the sample processing, e.g. the DNA extraction, DNA purification and amplification phases. This ensures that the data patterns are familiar to the forensic geneticists, and that previous experience and expert knowledge may be used later in the testimony to the court. When the raw data is generated and software (e.g. Gene Scan and Genotyper, Applied Biosystems, CA) has been used to call loci and alleles, the data are given as input to the DNA mixture separating algorithm. The algorithm returns the result from the separation which the forensic geneticist interprets and includes in the case report.

Differences from Previous Methods
The covariance structure specified in equation (1), where diag(hₛ) is used for proportionality of the mean and variance has not previously been proposed.
The update scheme for a such that the estimate is given by

$${\tilde{α}}_{\tilde{T}} ( s , i ) = \frac{{α}_{s , i}^{( 1 )} + {\sum }_{t ∈ \tilde{T}} {α}_{t , jt}^{( 1 )}}{{α}_{s , i}^{( 2 )} + {\sum }_{t ∈ \tilde{T}} {α}_{t , jt}^{( 2 )}} ,$$

where \tilde{T} is the set of previously visited loci, α_{t,j}_{ₜ}⁽¹⁾ is the numerator component for locus t and combination jₜ (similar for α_{t,j}_{ₜ}⁽²⁾ in the denominator), and α_{s,i}⁽¹⁾ and α_{s,i}⁽²⁾ are the numerator and denominator terms for combination i on the current locus s. This successive update of α has not previously been applied in forensic genetics.
The successive “build-up” of the profile has not previously been proposed in terms of an algorithm not involving decisions of a case worker.

### Modeling Peak Areas of a Two-Person Mixture

The kits used for typing a genetic stain comprises a set of loci, \tilde{S}, used for discrimination. For an arbitrary two-person mixture the number of possible combinations are given by 1^{S}^{₁} 7^{S}^{₂} 12^{S}^{₃} 6^{S}^{₄}, where Sᵢ is the number of loci with i observations and S=Σᵢ₌₁⁴Sᵢ, is the total number of loci used for discrimination, i.e. S is the size of \tilde{S}. The numbers 1, 7, 12 and 6 comes from the number of combinations possible (see Table 1) when observing 1, 2, 3 and 4 alleles, respectively. In most cases, this leads to an intractable number of combinations. However, using the quantitative STR data (peak heights and peak areas), the number of plausible combinations often decreases substantially.

For the search of a pair of best matching profiles to be feasible, we assume the peak areas of the different loci to be conditionally independent given the loci area sums A₊. Performing the inference conditioned on A₊ satisfy the reasoning of [1] as A₊ is an ancillary statistic for the mixture ratio. Furthermore, we assume that the conditional mean vector, E(Aₛ|A_{s,+}), and covariance matrix, Cov(Aₛ|A_{s,+}), are defined as

$$E ( {A}_{s} \vert {A}_{s , +} ) = [ α {P}_{s , 1} + ( 1 - α ) {P}_{s , 2} ] \frac{{A}_{s , +}}{2} \\ Cov ( {A}_{s} \vert {A}_{s , +} ) = {τ}^{2} {C}_{s} diag ( {h}_{s} ) {C}_{s}^{T} \qquad ( 1 )$$

where α denotes the proportion with which person 1 contributes to the mixture, and Cₛ=lₙ_{ₛ}−n⁻¹1ₙ_{ₛ}1ₙ_{ₛ}^{T} with nₛ being the number of observed peaks at locus s. Note that α is supposed to be common to all loci. The definition of the covariance matrix is close to the ordinary covariance when conditioning on the vector sum. However, as the variance of the peak areas are assumed proportional to the mean, we use the diagonal matrix diag(hₛ), where hₛ is the associated peak heights on locus s, obtaining weighted observations that stabilize the variance. Note that τ² is a common variance parameter for all loci, sε\tilde{S}.

The P_{s,k}-vector is a vector of indicators taking values 0, 1 or 2 referring to the number of copies that person k has of each allele in the mixture on locus s. E.g., if the two individuals contributing to the mixture have genotypes (10, 12) and (14, 14), respectively, we will have P_{s,1}=(1,1,0)^{T} and P_{s,1}=(0,0,2)^{T}. Assuming no chromosomal anomalies, each individual carries two alleles at each locus which implies the sum of P_{s,k} to be 2 for all k.

### Finding Best Matching Pair of Profiles

In order to find the most likely pair of profiles matching the observed mixture under the assumptions made by the model, one can decrease the number of possibilities using the reasoning below. Let the observed peak areas within each locus, s, be sorted such that A_{s,(1)}< . . . <A_{s,(n}_{ₛ}₎, and assume that DNA₁<DNA₂, where DNAₖ is the amount of DNA contributed by person k.

Then, for a locus with four observed peaks, the only likely pair of profiles given the model relates the alleles with peak area (A_{s,(1)},A_{s,(2)}) and (A_{s,(3)},A_{s,(4)}) to person 1 and person 2, respectively. For loci with one observation, the two individuals need both to be homozygotic, while for two or three observations, the possible profiles are listed in Table 2.

TABLE 2
Possible profiles for loci with two and three observations.

| | P₁ | P₂ | P₁ | P₂ | P₁ | P₂ | P₁ | P₂ |
|---|---|---|---|---|---|---|---|---|
| | J₂: | | | | | | | |
| A₍₁₎ | 1 | 1 | 2 | 0 | 1 | 0 | 0 | 1 |
| A₍₂₎ | 1 | 1 | 0 | 2 | 1 | 2 | 2 | 1 |
| | J₃: | | | | | | | |
| A₍₁₎ | 2 | 0 | 1 | 0 | 1 | 0 | 0 | 1 |
| A₍₂₎ | 0 | 1 | 1 | 0 | 0 | 1 | 0 | 1 |
| A₍₃₎ | 0 | 1 | 0 | 2 | 1 | 1 | 2 | 0 |

In Table 2, we have suppressed the locus subscript such that P₁ and P₂ refers to the profiles of person 1 and person 2 on the particular locus, respectively, and the cell values to the number of alleles associated to the profiles. The reason for not considering the three and eight other combinations for loci with two and three observations, respectively, is that, for any of these combinations, one of the four combinations listed in Table 2 will be more likely under the model assumptions, i.e. have a better fit to the observed data. E.g. would P_{s,1}=(0,2)^{T} and P_{s,2}=(2,0)^{T} be unlikely as we assumed person 1 to have the lowest contribution and the second area to be the larger.

Discarding the information from peak areas and only using combinatorics, the numbers of possible pairs of profiles for loci with two, three and four observations are 7, 12 and 6, respectively. Thus, using the assumptions of the model, we decrease the number of profiles which needs to be examined in order to find the most likely profiles forming the observed mixture.

We assume the peak areas to be normally distributed with conditional mean and covariance as specified in (1). Due to the conditional independence of the loci, the overall estimates of α and τ² are found as sums over the loci. Let Wₛ=Cₛdiag(hₛ)Cₛ^{T}, then we can write the conditional distribution as Aₛ|A_{s,+}˜Nₙ_{ₛ}(αx₀^{s}−x₁^{s},τ²Wₛ), where x₀^{s}=(P_{s,1}−P_{s,2})A_{s,+}/2 and x₁^{s}=P_{s,2}A_{s,+}/2 are the terms of the mean, linear and constant in α, respectively. Solving the likelihood equation with respect to α and τ² yield the unbiased estimators

$$\hat{α} = \frac{{\sum }_{s ∈ \tilde{S}} {x}_{0}^{{s}^{T}} {W}_{s}^{-} ( {A}_{s} - {x}_{1}^{s} )}{{\sum }_{s ∈ \tilde{S}} {x}_{0}^{{s}^{T}} {W}_{s}^{-} {x}_{0}^{s}} \\ \hat{τ} = {N}^{- 1} {\sum }_{s ∈ \tilde{S}} {( {A}_{s} - \hat{α} {x}_{0}^{s} - {x}_{1}^{s} )}^{T} {W}_{s}^{-} ( {A}_{s} - \hat{α} {x}_{0}^{s} - {x}_{1}^{s} ) , \qquad ( 2 )$$

where N=n₊−S−1=Σ_{sε\tilde{S}}(nₛ−1)−1 and Wₛ⁻ is the generalized inverse of Wₛ. We have to use the generalized inverse as Wₛ has the rank nₛ−1. An approximation to this model assumes that the precision matrix, τ⁻²Wₛ⁻¹, is given by τ⁻²Cₛdiag(hₛ)⁻¹Cₛ^{T}. Hence, we have a closed form expression for the inverse covariance matrix yielding simple expressions for the estimators of a and τ²

$$\tilde{α} = \frac{{\sum }_{s ∈ \tilde{S}} {\sum }_{i = 1}^{{n}_{s}} {x}_{0 , i}^{s} ( {A}_{s , i} - {x}_{1 , i}^{s} ) {h}_{s , i}^{- 1}}{{\sum }_{s ∈ \tilde{S}} {\sum }_{i = 1}^{{n}_{s}} {x}_{0 , i}^{{s}^{2}} {h}_{s , i}^{- 1}}$$

$$\tilde{τ} = {N}^{- 1} {\sum }_{s ∈ \tilde{S}} {( {A}_{s , i} - \tilde{α} {x}_{0 , i}^{s} - {x}_{1 , i}^{s} )}^{2} {h}_{s , i}^{- 1}$$

where A_{s,i}, h_{s,i}, x_{0,i}^{s} and x_{1,i}^{s} i'th components of the respective vectors. We denote the unbiased maximum likelihood estimates for the two models as (\hat{α}, \hat{τ}) and (\tilde{α}, \tilde{τ}), respectively. The latter version is what is implemented online as discussed in Section 3.2.

In addition to the estimate of α, we are also interested in determining a confidence interval for α. The conditional variance of \hat{α} given A₊ is found using the covariance operator on both sides of (2),

$$Var ( \hat{α} \vert {A}_{+} ) = \frac{Cov ( {\sum }_{s ∈ \tilde{S}} {x}_{0}^{{s}^{T}} {W}_{s}^{-} ( {A}_{s} - {x}_{1}^{s} ) )}{{( {\sum }_{s ∈ \tilde{S}} {x}_{0}^{{s}^{T}} {W}_{s}^{-} {x}_{0}^{s} )}^{2}} \\ = \frac{{\sum }_{s ∈ \tilde{S}} {x}_{0}^{{s}^{T}} {W}_{s}^{-} Cov ( {A}_{s} \vert {A}_{+} ) {W}_{s}^{-} {x}_{0}^{s}}{{( {\sum }_{s ∈ \tilde{S}} {x}_{0}^{{s}^{T}} {W}_{s}^{-} {x}_{0}^{s} )}^{2}} \\ = \frac{{τ}^{2}}{{\sum }_{s ∈ \tilde{S}} {x}_{0}^{{s}^{T}} {W}_{s}^{-} {x}_{0}^{s}} \qquad ( 3 )$$

where we from the first to second equality used the conditional independence of Aₛ and Aₜ given A₊, and second to third properties of the covariance together with the expression of Cov(Aₛ|A_{s,+}) in (1). The confidence interval of α given A₊ is then given by

$${CI}_{β} ( α ) = \hat{α} \pm {t}_{( 1 - β / 2 , N )} \frac{\hat{τ}}{\sqrt{{\sum }_{s ∈ \tilde{S}} {x}_{0}^{{s}^{T}} {W}_{s}^{-} {x}_{0}^{s}}}$$

where t_{(1-β/2,N)} is the critical value on significance level β for a t-distribution with N=n₊−S−1 degrees of freedom. A similar confidence interval using the (\tilde{α}, \tilde{τ})-estimates is obtained replacing the estimates and W⁻¹ for W⁻. From the expression of Cl_{β}(α), it is obvious that a small r-estimate decreases the width of the confidence interval and thus increases the believe in the estimated mixture proportion.

### Greedy Algorithm

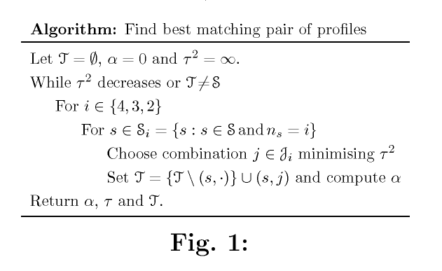

This model was used in an algorithm for finding the most likely pair of profiles contributing to an observed mixture where both individuals were assumed unknown. First, define the set J={J₁, . . . , J₄}, where Jᵢ is the set of plausible profiles for loci with nₛ=i. These sets were defined in Section 3 (Table 2). The pseudo code for a greedy algorithm finding a pair of profiles (locally) maximizing the likelihood of the model specified by (1) is given in FIG. 1. The algorithm works with both (\hat{α}, \hat{τ}) or (\tilde{α}, \tilde{τ}) as estimates of (α, τ). A greedy algorithm is any algorithm that solves a problem by making the locally optimum choice at each stage with the hope of finding the global optimum. FIG. 1 shows a greedy algorithm for finding a pair of profiles (locally) maximizing the likelihood of (1).

The greedy algorithm initiates by estimating a based on a locus s with four present alleles. The loci of S₄ contain full information on the mixture ratio, α, and are thus used for assessing this quantity. In succession, the loci with three and two (S₃ and S₂, respectively) observations are analyzed and the combination with the smallest contribution to τ and best concordance to the previously determined mixture proportion is chosen. The set \tilde{T} contains a list of the optimal combinations on previously visited loci and is updated after each iteration. On termination, the greedy algorithm returns the best matching pair of profiles together with the estimates α and. The algorithm is designed to perform calculations and decisions similar to those of a forensic geneticist when analyzing a two-person mixture.

The optimization problem is complicated since the inputs of the function that we are interested in minimizing depend on each other, ƒ(α,(P_{s,1},P_{s,2})_{sε\tilde{S}})=Σ_{sε\tilde{S}}Dₛ, where Dₛ=(Aₛ−\hat{α}x₀^{s}−x₁^{s})^{T}Wₛ⁻(Aₛ−\hat{α}x₀^{s}−x₁^{s}). Here, ƒ denotes the object function and (P_{s,1},P_{s,2})_{sε\tilde{S}} the set of possible combinations for all loci, sε\tilde{S}. It is easy to see that, for a fixed α, we can minimize Dₛ for each locus s by choosing the combination yielding the smallest square distance. Similarly, fixing the combinations for all loci, α is estimated using (2). However, from the construction of the greedy algorithm, the algorithm chooses the combination that minimizes τ² for locus s given the configurations on loci tε{\tilde{T}\s} and α. This ensures locally optimal solutions, and for most practical purposes, the algorithm returns a global maximum. One should note that when the algorithm recovers the best matching pair of profiles, we still need to consider all profiles close to these profiles consistent with the evidence for likelihood ratio evaluation (see Section 4 for further details).

### Online Implementation

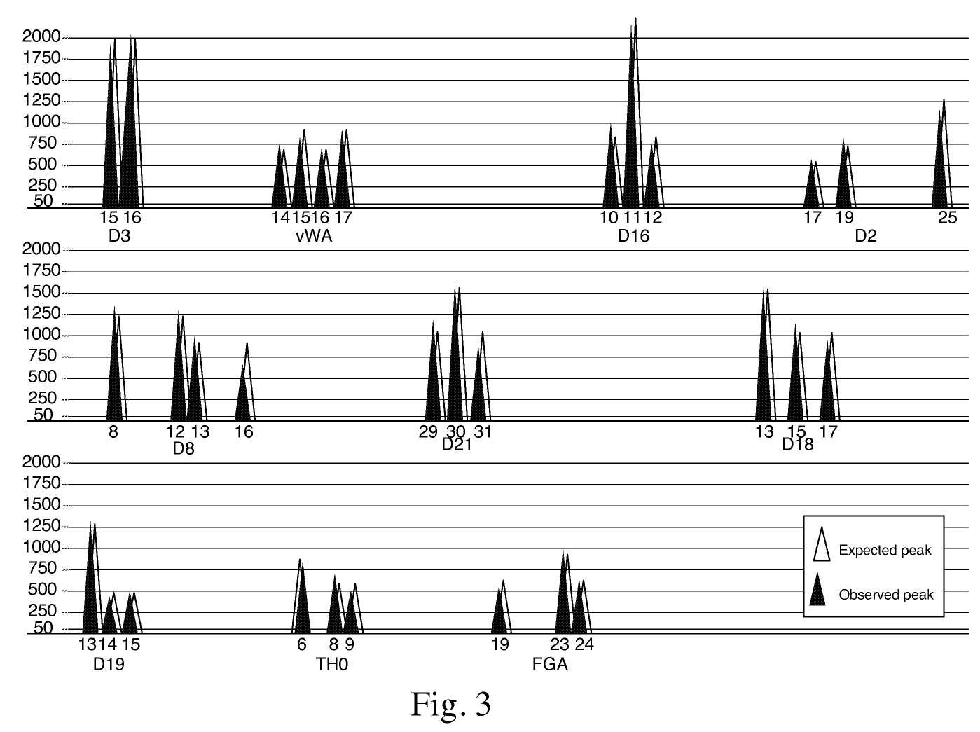

The greedy algorithm of FIG. 1 together with the methods for evaluating the goodness of fit for a given pair of profiles are implemented in an online application. The online implementation applies the (\tilde{α}, \tilde{τ})-estimates when finding the best matching pair of profiles. The two-person mixture separator is available at http://www.math.aau.dk/˜tvede/dna/. The script can plot the expected and observed peak areas for visual inspection of the fit (see FIG. 3).

The script allows for user uploads of csv-files containing information about loci, alleles, peak heights and peak areas. The loci implemented are those contained in the SGM+ and ldentifiler kits (Applied Biosystems) excluding amelogenin.

FIG. 3 is a plot produced by an implementation of the algorithm of FIG. 1 and showing a comparison of observed loci peaks and expected loci peaks. Apart from finding the best matching pair of unknown profiles, the user can specify a suspect profile, and the script finds the best matching unknown profile.

### Example of a Two-Person Mixture Separation

We demonstrate the algorithm and implementation on data from a controlled experiment conducted at the Section of Forensic Genetics, Department of Forensic Medicine, Faculty of Health Sciences, University of Copenhagen, Denmark. The data are presented in Table 3 together with information on the true profiles of the mixture (denoted by ∘ and •).

TABLE 3
Data used in demonstrating the algorithm.

| Locus | Allele | | | Height | Area |
|---|---|---|---|---|---|
| D3 | 15 | ∘ | • | 1802 | 15410 |
| D3 | 16 | ∘ | • | 1939 | 16282 |
| vWA | 14 | ∘ | | 712 | 6128 |
| vWA | 15 | | • | 725 | 6620 |
| vWA | 16 | ∘ | | 626 | 5637 |
| vWA | 17 | | • | 830 | 7362 |
| D16 | 10 | ∘ | | 824 | 7910 |
| D16 | 11 | | • | 1772 | 17231 |
| D16 | 12 | ∘ | | 586 | 6101 |
| D2 | 17 | ∘ | | 434 | 4558 |
| D2 | 19 | | • | 612 | 6563 |
| D2 | 25 | ∘ | • | 843 | 9257 |
| D8 | 8 | | • | 1284 | 10782 |
| D8 | 12 | | • | 1232 | 10359 |
| D8 | 13 | ∘ | | 903 | 7891 |
| D8 | 16 | ∘ | | 638 | 5291 |
| D21 | 29 | | • | 1073 | 9454 |
| D21 | 30 | ∘ | | 1469 | 12828 |
| D21 | 31 | | • | 798 | 6992 |
| D18 | 13 | ∘ | | 1247 | 12302 |
| D18 | 15 | | • | 899 | 9104 |
| D18 | 17 | | • | 726 | 7549 |
| D19 | 13 | | • | 1332 | 10534 |
| D19 | 14 | ∘ | | 416 | 3478 |
| D19 | 15 | ∘ | | 504 | 3968 |
| TH0 | 6 | ∘ | • | 820 | 6739 |
| TH0 | 8 | | • | 668 | 5573 |
| TH0 | 9 | ∘ | | 486 | 4004 |
| FGA | 19 | ∘ | | 490 | 4415 |
| FGA | 23 | ∘ | • | 865 | 7968 |
| FGA | 24 | | • | 527 | 5036 |

The ∘ and • represents profile 1 and 2, respectively.

The algorithm found that the two profiles of Table 4 are the best matching pair of profiles. The profiles are consistent with the true profiles of the mixture except for loci TH0 and FGA. In FIG. 3, we have plotted the data from Table 3 (solid cones) together with the best matching pair of profiles as listed in Table 4.

TABLE 4
Best matching pair of profiles for the data in Table 3. This pair of
profiles is pictured in FIG. 3 as the expected peaks.

| | Locus | | | | | | | | | |
|---|---|---|---|---|---|---|---|---|---|---|
| | D3 | vWA | D16 | D2 | D8 | D21 | D18 | D19 | TH0 | FGA |
| Minor | 15, 16 | 14, 16 | 10, 12 | 17, 25 | 13, 16 | 30, 30 | 13, 13 | 14, 15 | 6, 6 | 23, 23 |
| Major | 15, 16 | 15, 17 | 11, 11 | 19, 25 | 8, 12 | 29, 31 | 15, 17 | 13, 13 | 8, 9 | 19, 24 |

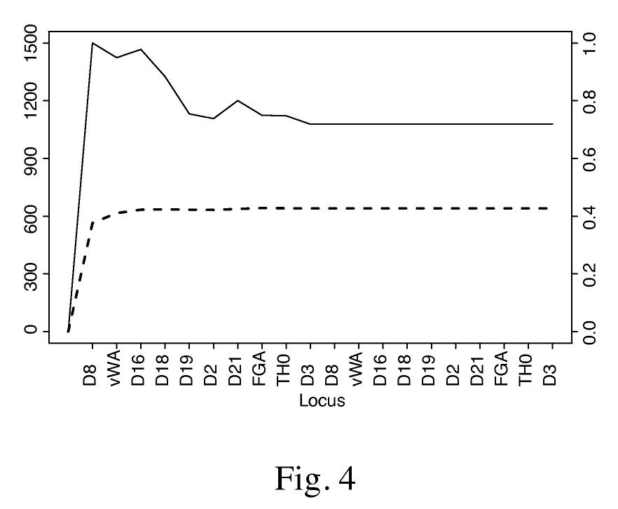

FIG. 4 shows a trace plot of the parameter estimates of the mixture ratio α (dashed) and the variance parameter τ² (solid) associated with the algorithm implementation of FIG. 3. In FIG. 4, the traces of the parameter estimates of a (dashed) and τ² (solid) are plotted for each successive iteration with the final parameter estimates being if \tilde{α}=0.43 (95%-Cl: [0.40; 0.45]) and \tilde{τ}²=1134.04.

Evaluating the mixture for the true profiles (marked by ∘ and • in Table 3), the α estimate is almost unchanged, but with an increase in \tilde{τ}² to 1266.34 indicating a slightly worse fit.

The fact that a combination different from the true one has a better fit, indicates that there are multiple explanations of the trace. However, the difference in \tilde{τ}²-estimates for the two combinations will only have a minor influence in the evaluation of the evidence.

### Dropping Non-Fitting Loci

In some cases, the stain may be contaminated, and it may be subject to drop-in or drop-out. In such cases, the observed peak heights and peak areas no longer originates solely from a two-person mixture. Hence, the proportionalities of Section 1 need no longer to be satisfied and the mean structure of (1) may not explain the observed peak heights and peak areas.

We use an F-test approach to evaluate whether any of the included loci sε\tilde{S} has significant unexpected balances due to e.g. stutters, degradation or contamination. The purpose is to return a list of loci in which the hypothesis of a two-person mixture can be supported.

For each locus, the contribution to τ² is computed by Dₛ, which we assume to follow a χₙ_{ₛ}₋₁²-distribution. Hence, to test whether any locus contributes significantly to the overall variance, τ², we evaluate for each locus sε\tilde{S} the ratio

$$\frac{{( {n}_{s} - 1 )}^{- 1} {D}_{s}}{{( {n}_{+} - S - {n}_{s} - 1 )}^{- 1} {\sum }_{t ∈ \{ \tilde{S} / s \}} {D}_{t}} \sim {F}_{( {n}_{s} - 1 ) , ( {n}_{+} - S - {n}_{s} - 1 )} ,$$

where Fᵥ_{₁}ᵥ_{₂} is a F-distribution with v₁ numerator and v₂ denominator degrees of freedom. Since we perform this test for all loci, we make a Bonferroni-correction to compensate for multiple testing. We apply this procedure successively and drop the most significant locus (if any) until no loci have a significant test-value.

If the variance contribution from multiple loci is large, the test-value will not indicate any significant locus as the overall noise is large or may be a mixture of more than two individuals. This will result in large values for the overall τ².

### Likelihood Ratio

Let \tilde{G} be the DNA profile of the crime stain, and G_{S} and G_{U}_{ᵢ} the profiles of the suspect and unknown contributor i, respectively. Furthermore, the evidence, \tilde{E}, consists of both quantitative information, \tilde{Q}, and the genetic crime stain, \tilde{G}. The probability P(\tilde{E}|H) factorizes as P(\tilde{Q}, \tilde{G}|H)=P(\tilde{Q}|\tilde{G}, H)P(\tilde{G}|H) using the definition of conditional probabilities. Since is a continuous stochastic variable, we use the likelihood of our model, L(A|G′, G″), to evaluate P(\tilde{Q}|\tilde{G}, H), where the hypothesis H involves profiles G′ and G″. Hence, the LR can be formed as,

$$LR = \frac{P ( \tilde{E} \vert {H}_{p} )}{P ( \tilde{E} \vert {H}_{d} )} = \frac{{\sum }_{{G}_{U} : ( {G}_{U} , {G}_{S} ) ≡ \tilde{G}} L ( A \vert {G}_{U} , {G}_{S} ) P ( {G}_{U} )}{{\sum }_{( {G}_{{U}_{1}} , {G}_{{U}_{2}} ) ≡ \tilde{G}} L ( A \vert {G}_{{U}_{1}} , {G}_{{U}_{2}} ) P ( {G}_{{U}_{1}} , {G}_{{U}_{2}} )} \qquad ( 4 )$$

where (Gᵢ,Gⱼ)≡\tilde{G} is the set of all pairs of profiles (Gᵢ,Gⱼ) consistent with \tilde{G}. Furthermore, Gᵢ:(Gᵢ, Gⱼ)≡\tilde{G} are all profiles, Gᵢ, together with a fixed Gⱼ that are consistent with \tilde{G}. The P(G) is the profile probability as applied in the regular likelihood ratio. This allows P(G) to be evaluated using of the θ-correction when appropriate [4]. If the two profiles G_{U}_{₁} and G_{U}_{₂}, are genetically unrelated P(G_{U}_{₁},G_{U}_{₂})=P(G_{U}_{₁})P(G_{U}_{₂}) by independence. If the case includes a victim with profile G_{V}, the likelihood ratio simplifies further

$$LR = \frac{L ( A \vert {G}_{V} , {G}_{S} )}{{\sum }_{{G}_{U} : ( {G}_{U} , {G}_{V} ) ≡ \tilde{G}} L ( A \vert {G}_{U} , {G}_{V} ) P ( {G}_{U} )}$$

In some cases, the value of L(A|G_{V},G_{S}) may be very much lower than the likelihood value for the pair of best matching profiles. This indicates that it is inappropriate to assume that the evidence is a mixture of G_{S} and G_{V}—even though the profiles are consistent with \tilde{G}.

The sums involved in the evaluation of the likelihood ratio will often involve an intractable number of terms depending, on the number of loci and number of observed peaks in each locus. As the inclusion of all possible combinations is infeasible, we need at least to include combinations with a numerical impact on the likelihood ratio for the approximation of the true likelihood ratio to be satisfactory for forensic use.

The best matching pair of profiles will provide an estimate, of the mixture proportion α. The expected peak areas in Table 5 (expressed in terms of α) indicate that alternative combinations need to have an α-estimate close to the estimate of the best matching pair in order to have a reasonable fit. We exploit this result when defining our proposal distribution in the section on importance sampling.

TABLE 5
Expected peak areas for a two-person
mixture (expressed in term of α).

| nₛ | Alleles | Combinations | Expected peak areas in terms of α |
|---|---|---|---|
| 1 | a⁴ | (aa, aa) | (2) |
| 2 | a³ b | (aa, ab), (ab, aa) | (1 + α, 1 − α), (2 − α, α) |
| | a² b² | (aa, bb), (ab, ab) | (2α, 2(1 − α)), (1, 1) |
| 3 | a² bc | (aa, bc), (ab, ac), | (2α, 1 − α, 1 − α), (1, α, 1 − α), |
| | | (bc, aa) | (1 − α, 1 − α, 2α) |
| 4 | abcd | (ab, cd), (ac, bd) | (α, α, 1 − α, 1 − α), (α, 1 − α, |
| | | | α, 1 − α) |

The list is minimal such that equivalent combinations up to numeration of alleles are avoided.

### Importance Sampling of the Likelihood Ratio

An exact assessment of the weight of evidence comprises evaluation of every term of the numerator and denominator of (4). However, this is infeasible and other methods of evaluating the evidence need to be considered. In this section, we show how importance sampling (IS) can be used, for estimation of the weight of evidence by assigning weights to the individual combinations.

The expression of P(\tilde{E}|H_{d}) can be interpreted as a expectation of \tilde{Q} with respect to the probability measure P on \tilde{G},

$$P ( \tilde{E} \vert {H}_{d} ) = E ( f ( \tilde{E} ) ; P ) = {\sum }_{G ≡ \tilde{G}} L ( A \vert G ) P ( G ) ; \qquad ( 5 )$$

where G refers to a pair of profiles G=(G′, G″) and is used for notational simplicity.

Hence, simulating combinations G from \tilde{G} with respect to P may be used to estimate P(\tilde{E}|H_{d}). However, simulation with respect to P does not take the quantitative evidence, \tilde{Q}, into account and will thus yield a poor estimate of P(\tilde{E}|H_{d}) due to the larger numerical impact from L(A|G) compared to P(G). To handle this we use IS based on the “marginal” likelihood values of each combination.

Let q(G)=Π_{sε\tilde{S}}qₛ(Gₛ) where Gₛ=(G′ₛ,G″ₛ) is the profiles on locus s and

$${q}_{s} ( {G}_{s} ) = \frac{L ( A \vert {G}_{s} , {\hat{G}}_{- s} ) P ( {G}_{s} )}{{\sum }_{i = 1}^{{N}_{s}} L ( A \vert {G}_{s , i} , {\hat{G}}_{- s} ) P ( {G}_{s , i} )} \qquad ( 6 )$$

where Nₛ is the number of combinations for the observed number of alleles and (Gₛ,Ĝ₋ₛ) is the particular combination on locus s merged with the best matching combination on the remaining loci, tε{\tilde{S}\s}. Hence, L (A|Gₛ,Ĝ₋ₛ) is called the “marginal” likelihood as it gives the likelihood for the particular combination on locus s with the combinations on the remaining loci identical to the best matching pair of profiles. Furthermore, the denominator of (6) is a constant, Bₛ, for each locus. Using this proposal distribution, P(\tilde{E}|H_{d}) may be expressed as an expectation with respect to q,

$$P ( \tilde{E} \vert {H}_{d} ) = {\sum }_{G ≡ \tilde{G}} L ( A \vert G ) \frac{P ( G )}{q ( G )} q ( G ) = E ( f ( \tilde{E} ) W ( \tilde{E} ) ; q ) ,$$

where W(\tilde{E})=P(G)/q(G) is the importance weight. Since P(G)=Π_{sε\tilde{S}}P(Gₛ) and B=Π_{sε\tilde{S}}Bₛ, the ratio of L(A|G)P(G)/q(G) is nearly constant,

$$\frac{L ( A \vert G ) P ( G )}{\frac{{\prod }_{s ∈ \tilde{S}} L ( A \vert {G}_{s} , {\hat{G}}_{- s} ) P ( {G}_{s} )}{{\prod }_{s ∈ \tilde{S}} {B}_{s}}} = \frac{L ( A \vert G ) B}{{\prod }_{s ∈ \tilde{S}} L ( A \vert {G}_{s} , {\hat{G}}_{- s} )} ,$$

where the product in the denominator in many cases is a good approximation to L(A|G). This constantness improves the performance of IS and reduces the number of samples needed for results with low variance [3].

In order to estimate P(\tilde{E}|H_{d}), we draw combinations Gᵢ, i=1, . . . , M, from q(G) and compute the Monte Carlo estimate,

$$\hat{P} ( \tilde{E} \vert {H}_{d} ) = \frac{1}{M} {\sum }_{i = 1}^{M} L ( A \vert {G}_{i} ) w ( {G}_{i} ) , {G}_{i} ∼ q ( G ) ,$$

where w(Gᵢ)=P(Gᵢ)/q(Gᵢ) are the importance weights.

The estimate is unbiased as the terms are independently simulated from q(G) and all have expectation E(ƒ(\tilde{E})W(\tilde{E}); q)=P(\tilde{E}|H_{d}). For the variance, we compute

$$Var [ {\hat{P}}^{ } ( \tilde{E} \vert {H}_{d} ) ] = \frac{1}{M - 1} {\sum }_{i = 1}^{M} \{ {[ L ( A \vert {G}_{i} ) w ( {G}_{i} ) ]}^{2} - {\hat{P} ( \tilde{E} \vert {H}_{d} )}^{2} \} .$$

For numerical purposes, we compute each term relative to L(A|Ĝ) with a subsequent correction of the estimate.

The numerator of LR can be handled similarly taking into consideration that we are summing over a restricted set of combinations, F(S), all including the suspect's profile, where F(S)={G_{U}:(G_{U},G_{S})≡\tilde{G}}. The greedy algorithm of FIG. 1 is also applicable when specifying a suspect. We only need another ordering of the observations and a different set of J-matrices using the extra information of the suspect profile. This implies that there exists a best matching combination, Ĝ_{(S)}, in the restricted set, F(S), having the same properties as Ĝ for the complete set of combinations. Hence, importance sampling may also be used in estimating P(\tilde{E}|Hₚ) with similar formulae as those for estimating P(\tilde{E}|H_{d}).

### Example of Estimating LR Using IS

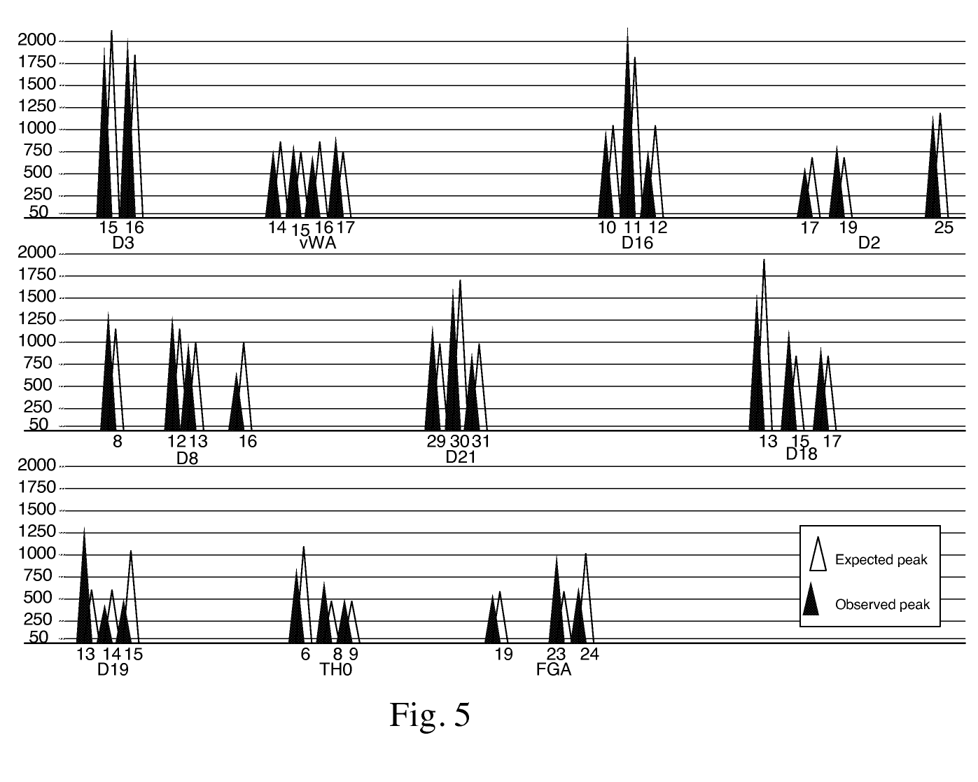

The best matching pair of profiles for the data in Table 3 was found in Table 4 and are used for estimating q(G) and the constant B. In the computations, we assumed uniform distributions of the allele probabilities. In Table 6, we list the profile of a fictive suspect, G_{S}, together with the unknown profile maximizing the likelihood with G_{S} fixed. This pair plays the role of Ĝ_{(S)} in this example. We plot the observed and expected peak heights assuming a mixture of these profiles in FIG. 5.

TABLE 6
Suspect profile together with best matching unknown.

| | Locus | | | | | | | | | |
|---|---|---|---|---|---|---|---|---|---|---|
| | D3 | vWA | D16 | D2 | D8 | D21 | D18 | D19 | TH0 | FGA |
| Suspect | 16, 16 | 15, 17 | 11, 11 | 25, 25 | 13, 16 | 30, 30 | 15, 17 | 15, 15 | 8, 9 | 24, 24 |
| Unknown | 15, 15 | 14, 16 | 10, 12 | 17, 19 | 8, 12 | 29, 31 | 13, 13 | 13, 14 | 6, 6 | 19, 23 |

FIG. 5 shows a plot of the observed peaks and the expected peaks assuming a mixture of the suspect and best matching unknown (profiles of Table 6).

In order to verify the validity of our methodology and implementation of the importance sampler, we limited our data to include only loci on the blue fluorescent dye band (D3, vWA, D16 and D2). The total number of possible combinations for the blue loci is 7¹12²6¹=6,048 and it is therefore possible to compute the correct value of P(\tilde{E}|H_{d})=4.81335×10⁻¹¹. For the suspect profile specified in Table 6, locus D3 is the only blue locus for which it is possible to alter the unknown profile and still have consistency with \tilde{G}. Hence, there are only two terms in the P(E|Hp) when restricting the analysis to the blue dye band.

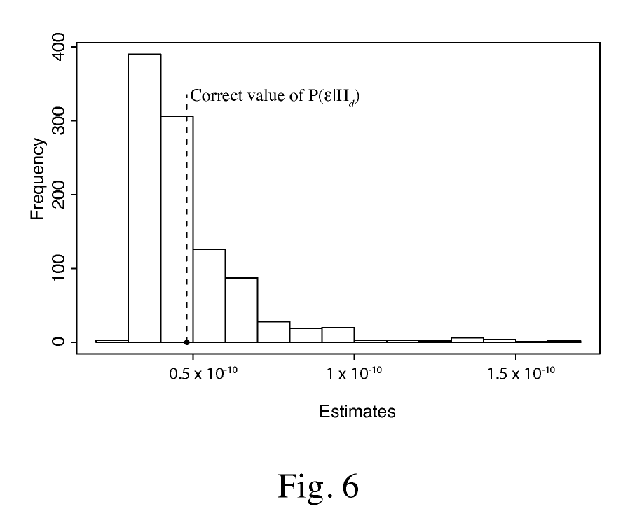

In order to evaluate the performance of the importance sampler, we computed 1,000 estimates of P(\tilde{E}|H_{d}) each based on 10,000 samples. The estimates are plotted together with the correct value in the histogram of FIG. 6. The distribution of the estimates tends to be skew for this particular example, but with most of the estimates close to the true value of P(\tilde{E}|H_{d}).

FIG. 6 shows a histogram of 1,000 importance sample estimates of P(\tilde{E}|H_{d}) each based on 10,000 samples.

### Results

The algorithm were tested on data from 71 controlled two-person mixtures with known profiles. For these cases it is therefore possible to estimate τ for the true mixture, τ_{T}, and compare this to the estimate for the best matching pair of profiles, τ_{Ĝ}. The ratio (\tilde{τ}_{Ĝ}/\tilde{τ}_{T})^{N} compares the deviation between the true profiles and the best matching pair of profiles. Ratios close to 1 indicates the fit of the two pairs of profiles is similar; whereas larger values suggest the true pair of profiles are inconsistent with the model assumptions.

The greedy algorithm returned the true mixture as the best matching combination 18 times. In 37 cases, the ratio of likelihood values, (\tilde{τ}_{Ĝ}/\tilde{τ}_{T})^{N}, were less than five. In a few cases, there were unexpected differences between the likelihood value of true pair of profiles, and that of the best matching pair. Further investigation indicated that the same pair of profiles in different mixture ratios caused these large differences. A possible explanation is that the behaviour of stutters (unfiltered data were used in this analysis) are similar for these cases since the contributing profiles are the same. Hence, systematic deviations of the observed from the expected peaks are possible.

### Discussion

Using the quantitative information from DNA analysis in terms of peak intensities is presently the only way to separate STR DNA mixture results. Based on a statistical model, we developed a simple greedy algorithm for finding the best matching pair of profiles.

Our model is based on few assumptions that are widely accepted among forensic geneticists. The statistical model made it possible to make objective comparisons of different combinations by evaluating the likelihood values. From the normal distribution assumption, this value is computed by τ^{-N}, which implies that, the lower τ estimate, the better concordance between observed and expected peaks.

Importance sampling was used in order to estimate the likelihood ratio since this becomes computationally difficult when 7^{S}^{₂}12^{S}^{₃}6^{S}^{₄} terms need to be evaluated. The method showed to be efficient, and future work will consist of implementation of sampling schemes that explore more of the sample space.

### Conclusion

The greedy algorithm of Section 3.1 demonstrated that it is possible to automate the separation of DNA mixtures. However, due to the assumption of no occurrence of drop-out or stutters, the model may be too simple for more complicated cases. Hence, this methodology is applicable to cases where the analysis today is standard but time-consuming. This allows the forensic geneticists to focus on more complex crime cases.

Future work comprises the development of a methodology for handling drop-outs and stutters. Since stutters are profile independent (stutters from parental peaks are constant for all alleged combinations), it is feasible to remove stutters from the data prior to separation and interpretation (see [8]). Allowing for drop-outs while finding a best matching pair of profiles is also possible. Using the methodology of [6], the probability of drop-out, P(D|H), is assessable conditioned on a given profile.

The General Case with m Contributors

In the general case with in contributors to the mixed stain, our method can be generalized by assuming the mixture proportions (α₁, . . . , αₘ) to be strictly increasing,

$${α}_{1} < ⋯ < {α}_{m} = 1 - {α}_{+} where {α}_{+} = {\sum }_{i = 1}^{m - 1} {α}_{i} . \qquad ( 7 )$$

Furthermore, for a matrix to be considered a part of the “best matching”-class, it needs to satisfy that

$${\sum }_{j = 1}^{m} {P}_{s , j} ( i ) > {\sum }_{j = 1}^{m} {α}_{j} {P}_{s , j} ( {i}^{′} ) for all row indicies i > {i}^{′} , \qquad ( 8 )$$

where P_{s,j}=(P_{s,j}(1), . . . , P_{s,j}(nₛ))^{T}.

The conditional covariance structure is the same as specified in (1), where the conditional mean is given as

$$E ( {A}_{s} \vert {A}_{s , +} ) = \frac{{A}_{s , +}}{2} [ {\sum }_{i = 1}^{m - 1} {α}_{i} {P}_{s , i} + {P}_{s , m} ( 1 - {\sum }_{i = 1}^{m - 1} {α}_{i} ) ] \qquad ( 9 )$$

where X_{s,i}=(P_{s,i}−P_{s,m})A_{s,+}/2 for i=1, . . . , m−1 and X_{s,m}=P_{s,m}A_{s,+}/2. In order to find the MLE of α=(αᵢ)ᵢ₌₁^{m-1}, we solve the likelihood equations for l(α,τ²;(Aₛ)sεS) with respect to α, which is given as

$$l ( α , {τ}^{2} ; {( {A}_{s} )}_{s ∈ S} ) ∝ {\sum }_{s ∈ S} \frac{- 1}{2 {τ}^{2}} {( {\tilde{A}}_{s} - {X}_{s} α )}^{T} {W}_{s}^{-} ( {\tilde{A}}_{s} - {X}_{s} α ) ,$$

where Ãₛ=Aₛ−Xₘ and Xₛα is the sum of (9) written as a matrix product of Xₛ=[X_{s,1} . . . X_{s,m-1}] and α. Making use of differentiation rules of matrix expressions, i.e.

$$\frac{d}{d x} Ax = {A}^{T} and \frac{d}{d x} {x}^{T} Bx = 2 Bx ,$$

we get

$$\frac{d}{d α} l ( α , {τ}^{2} ; {( {A}_{s} )}_{s ∈ S} ) = {\sum }_{s ∈ S} 2 {X}_{s}^{T} {W}_{s}^{-} {X}_{s} - 2 {X}_{s}^{T} {W}_{s}^{-} {\tilde{A}}_{s} .$$

Setting this equal to zero implies that the MLE of α is

$$\hat{α} = {( {\sum }_{s ∈ S} {X}_{s}^{T} {W}_{s}^{-} {X}_{s} )}^{- 1} ( {\sum }_{s ∈ S} {X}_{s}^{T} {W}_{s}^{-} ( {A}_{s} - {X}_{s , m} ) ) .$$

We see that in (2), x₁^{s} plays the role of X_{s,m} and similarly for x₀^{s} and Xₛ. Hence, it can also be shown that the estimate of τ² in the general setting is

$${\hat{τ}}^{2} = {N}^{- 1} {\sum }_{s ∈ S} {( {A}_{s} - {X}_{s} \hat{α} - {X}_{s , m} )}^{T} {W}_{s}^{-} ( {A}_{s} - {X}_{s} \hat{α} - {X}_{s , m} ) ,$$

where N=n₊−S−m+1=τ_{sεS}(nₛ−1)−(m−1).

### Greedy Algorithm

The greedy algorithm of FIG. 1 needs only a few modifications to be applicable to the general case. Most important is the specification of the number of contributors, m. This needs to be decided before running the algorithm. For the algorithm to be successful, there should preferably be at least one locus with 2m peaks as this increases the confidence in the estimated \hat{α}.

Furthermore, it is necessary to check if the \hat{α}-estimate satisfies the inequalities of (7) for each combination. In Table 7, we list fictive data together with two combinations both implying a perfect fit. Both matrices are valid as the order in the α-sum columns satisfy the conditions of (8). However, for Combination 1 the estimate \hat{α}₁=(0.2, 0.45) does not satisfies (7) while the estimate for Combination 2 \hat{α}₂=(0.2, 0.35) does.

TABLE 7
Fictive data showing the importance of ensuring (7) is satisfied.

| | Combination 1 | | | | Combination 2 | | | |
|---|---|---|---|---|---|---|---|---|
| Area | P₁ | P₂ | P₃ | α-sum | P₁ | P₂ | P₃ | α-sum |
| 200 | 1 | 0 | 0 | α₁ | 1 | 0 | 0 | α₁ |
| 450 | 0 | 1 | 0 | α₂ | 0 | 0 | 1 | 1 − α₊ |
| 550 | 1 | 0 | 1 | 1 − α₂ | 1 | 1 | 0 | α₁ + α₂ |
| 800 | 0 | 1 | 1 | 1 − α₁ | 0 | 1 | 1 | 1 − α₁ |

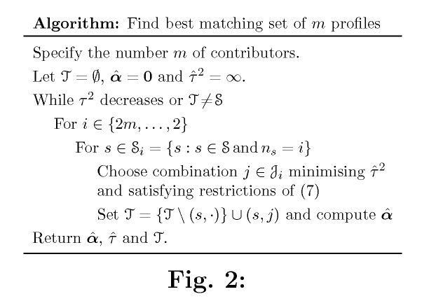

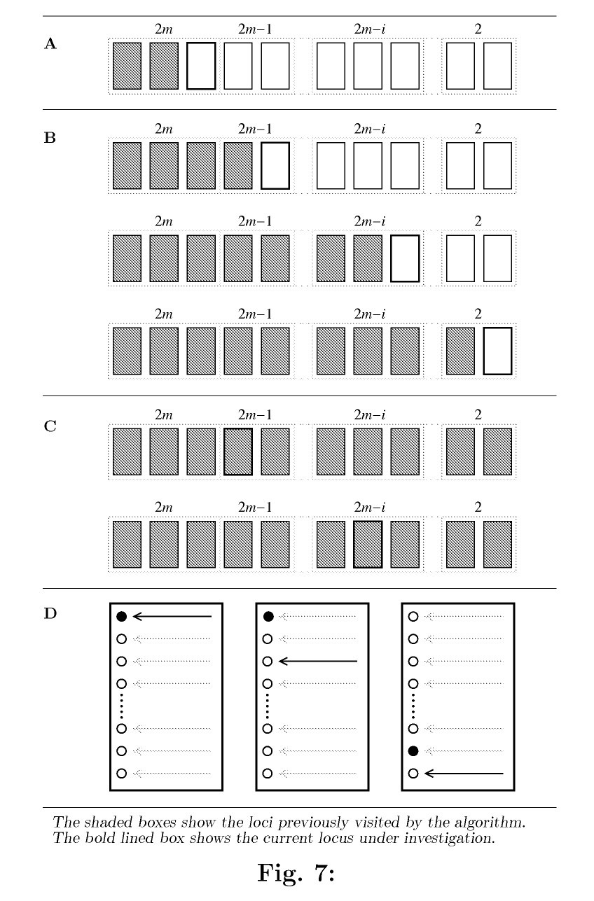

FIG. 7 is a symbolic chart corresponding to the algorithm of FIG. 2 and symbolizing a method of determining the best matching combination of variables indicating the number of allele copies from each contributor to an observed DNA mixture.

In step A the parameters α and τ is estimated using only the loci with 2m observed peaks. Step B determines the profile combination (see step D) on the current locus that minimizes τ given the combinations on the already visited loci. The algorithm visits the blocks in decreasing order: 2m−1, . . . , 2. If any of the blocks is empty the algorithms skips forward to the next nonempty block. The order within each block of loci with 2m−i observed peaks is arbitrary. When reaching the last locus, the combination and estimates of α and τ is saved.

In step C the algorithm visits each locus searching for a combination that might decrease τ with all remaining loci combinations fixed. If τ is non-changed the algorithm stops. Otherwise step C is looped until a fixed τ-value is obtained. On termination the algorithm returns the combination and estimates of α and τ.

Step D pictures that for each locus with less than 2m peaks, there are several combinations of profiles that need to investigated. In the figure each ∘ depicts a combination and • symbolizes the current optimal configuration. The black arrow shows which combination that is currently tested. When all the combinations are tested the one with smallest τ is returned.

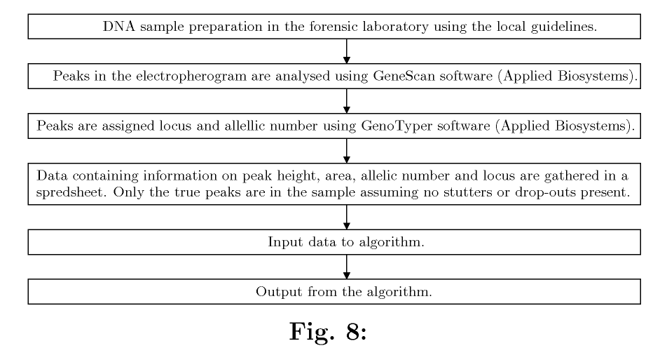

FIG. 8 is a flowchart illustrating how an algorithm corresponding to FIG. 1 or FIG. 2 may be incorporated in the work at a forensic laboratory. First the DNA sample is prepared in the forensic laboratory using the local guidelines. The data necessary for application of the algorithm is obtained by using GeneScan and GenoTyper software (both Applied Biosystems) on the peaks in the electropherogram. A spreadsheet containing information on peak height, area, allelic number and locus is fed to the algorithm. The algorithm outputs a best matching profile and parameters for inspection by a forensic geneticist.

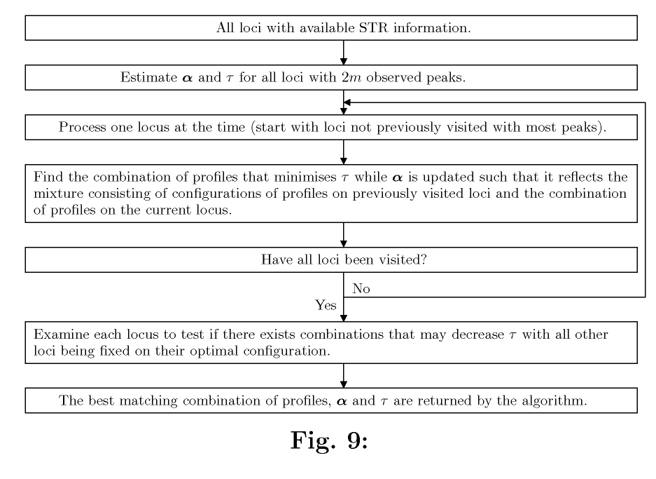

The flowchart in FIG. 9 shows the steps of the method corresponding to the symbolic chart of FIG. 7. All loci with available STR information are used in the analysis. Loci with 2m observed peaks are used to obtain initial estimates of α and τ. The algorithm visits not previously visited loci one at the time in decreasing order by the number of observed peaks. For each locus the algorithm selects the combination of profiles that minimizes τ while α is updated such that it reflects the mixture consisting of configurations of profiles on previously visited loci and the combination of profiles on the current locus. When all loci have been visited, each locus is examined to test if there exists combinations that may decrease τ with all other loci being fixed on their optimal configuration. On termination, the best matching combination of profiles, α and τ are returned by the algorithm.

### REFERENCES

[1]Cox, D R. (1958). ‘Some problems connected with statistical inference’. The Annals of Mathematical Statistics, 29(2): 357-372.
[2] Perlin, M W., Szabady, B. (2001). ‘Linear mixture analysis: A mathematical approach to resolving mixed DNA samples’. Journal of Forensic Science, 46(6): 1372-1378.
[3] Robert, C P., Casella, G. (2004). ‘Monte Carlo Statistical Methods’. 2ed. Springer.
[4] Buckleton, J S., Triggs, C M., Walsh, S J. (2005). ‘Forensic DNA evidence interpretation’, Mixtures (Chapter 7). CRC Press.
[5] Wang, T., Xue, N., Birdwell, J D. (2006) ‘Least-Square Deconvolution: A Framework for Interpreting Short Tandem Repeat Mixtures’. Journal of Forensic Science, 51(6): 1284-1297.
[6]Tvedebrink, T., Eriksen, P S., Mogensen, H S., Morling, N. (2009). ‘Estimating the probability of allelic drop-out of STR alleles in forensic genetics’. Forensic Science International: Genetics, 3(4): 222-226.
[7]Tvedebrink, T., Eriksen, P S., Mogensen, H S., Morling, N. (2009). ‘Evaluating the weight of evidence using quantitative STR data in DNA mixtures’. Accepted for publication by Applied Statistics.
[8]Tvedebrink, T., Eriksen, P S., Mogensen, H S., Morling, N. (2009). ‘Stochastic filtering of quantitative data from STR DNA analysis’. Manuscript in preparation for publication.

1. A computer assisted method of analyzing a DNA mixture having two or more individual contributors m by use of STR technology, said method comprising:
(1.a) obtaining, for a number S of STR loci, observed peak area data vector and observed peak height data vector for each peak within a locus, and observed allele data informing which alleles are observed for each locus;
(1.b) obtaining peak area model data for peak area vectors (A₁, . . . , A_{S}) by use of a statistical model assuming a normal distribution for the peak areas and assuming conditional independence of the peak area vectors given the sums of the peak areas within each locus;
(1.c) herein for the statistical model a conditional mean vector is given by
$$E ( {A}_{s} \vert {A}_{s , +} ) = \frac{{A}_{s , +}}{2} {\sum }_{i = l}^{m} {α}_{i} {P}_{s , i} ,$$
where A_{s,+} is the sum of peak areas within locus s, (α₁, . . . , αₘ) is a mixture ratio parameter vector with αᵢ denoting the share that individual i has contributed to the DNA mixture and α₁< . . . <αₘ are ordered in increasing order, and where P_{s,i} is a vector variable of indicators giving the number of copies that contributor i has of each allele in the DNA mixture of locus s;
(1.d) and wherein for the statistical model a conditional covariance matrix is given by Cov(Aₛ|A_{s,+})=τ²Cₛdiag(hₛ)Cₛ^{T}, where τ is a variance parameter being a common variance to all loci, diag(hₛ) is a diagonal matrix with the associated peak heights on locus s, Cₛ=lₙ_{ₛ}−n⁻¹1ₙ_{ₛ}1ₙ_{ₛ}^{T}, where nₛ is the number of observed peaks at locus s, lₙ is the n-dimensional identity matrix, and 1ₙ, is an n-dimensional column-vector of ones;
(1.e) said method further comprising determining an estimate for the mixture ratio vector (α₁, . . . , αₘ), and further determining an estimate for the variance parameter τ, said estimations being based on a comparison of the obtained peak area data and the modeled peak area data.

2. A method according to claim 1, wherein said estimate of the mixture ratio vector and the variance parameter is performed by use of bias-corrected maximum likelihood estimators.

3. A method according to claim 1, said method further comprising: determining, for each locus s of the S loci and by use of the statistical model defined in (1.b)-(1.d), a best matching combination [P_{s,1}, . . . , P_{s,m}] of variables indicating the number of allele copies from each contributor, 1, . . . , m, to the mixture and thereby specifying the DNA mixture, said best matching combination being the combination giving the smallest variance parameter τ.

4. A method according to claim 3, wherein the method of determining the best matching combination comprises the steps of:
(4.a) estimating the mixture ratio vector (α₁, . . . , αₘ) and the variance τ for all loci with 2m observed peaks using the statistical model defined in (1.b)-(1.d), and setting P_{s,i} fixed such that it assigns the two lowest peaks to contributor 1, the two next lowest peaks to contributor 2 and so forth;
(4.b) estimating the mixture ratio vector (α₁, . . . , αₘ) and the variance r for each of the remaining loci and for each allowable combination of the indicator variable [P_{s,1}, . . . , P_{s,m}] using the statistical model defined in (1.b)-(1.d), taking one locus at the time and starting with the loci having most peaks and then in a decreasing order of peaks, identifying a best matching combination of [P_{s,1}, . . . , P_{s,m}], which minimizes the estimate of τ, while the mixture ratio vector (α₁, . . . , αₘ) for each combination of [P_{s,1}, . . . , P_{s,m}] under consideration is re-estimated based on the identified combinations [P_{s,1}, . . . , P_{s,m}] of previously visited loci and the identified combination of [P_{s,1}, . . . , P_{s,m}] at the current locus in order to ensure that the mixture ratio (α₁, . . . , αₘ) fits with both the previously visited loci and the current locus, where the estimated mixture ratio vector for the selected combination of indicator variables [P_{s,1}, . . . , P_{s,m}] satisfies α₁< . . . <αₘ; and
(4.c) storing the obtained best matching combinations of [P_{s,1}, . . . , P_{s,m}] and the resulting estimate of the mixture ratio vector (α₁, . . . , αₘ) and the resulting minimum estimate of the variance τ, which is the weigthed mean with weights (nₛ−1) of the obtained minimum estimates of τₛ for each locus s.

5. A method according to claim 4, wherein the determining of said the best matching combination further comprises the steps of:
(5.a) determining for each locus, while using the statistical model defined in (1.b)-(1.d), if there is a combination of indicator variables [P_{s,1}, . . . , P_{s,m}] resulting in a lower estimate of the variance τ than for the already identified best matching combination, while maintaining the identified best matching combinations of [P_{s,1}, . . . , P_{s,m}] for the remaining loci, and if there is any such new combination, identifying said new combination as the best matching combination for the locus being investigated, and updating the resulting minimum estimate of the variance τ;
(5.b) returning for each locus the obtained best matching combination [P_{s,1}, . . . , P_{s,m}] of variables, and further returning the obtained resulting minimum estimate of the variance τ and the resulting estimate of the mixture ratio (α₁, . . . , αₘ).
